(19) United States
(12) Patent Application Publication
(10) Pub. No.: US 2010/0232071 A1
(43) Pub. Date: Sep. 16, 2010

(54) PERPENDICULAR MAGNETIC RECORDING MEDIUM, METHOD OF MANUFACTURING THE SAME, AND MAGNETIC RECORDING/PLAYBACK APPARATUS

(75) Inventors: Susumu OGATA, Kawasaki (JP); Hiroshi CHIBA, Kawasaki (JP); Masayuki TAKEDA, Kawasaki (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/725,389

(22) Filed: Mar. 16, 2010

(30) Foreign Application Priority Data
Mar. 16, 2009 (JP) 2009-062198

(51) Int. Cl. G11B 5/127; G11B 21/16

(52) U.S. Cl. 360/246.2; 427/595; G9B/21.023

(57) ABSTRACT

According to one embodiment, a magnetic head includes a slider, a recording/reproduction element formed on a distal end face of the slider, and a resin film formed at least on the recording/reproduction element and the distal end face and having at least one of water repellency and oil repellency.

### CROSS-REFERENCE TO RELATED APPLICATIONS

This application is based upon and claims the benefit of priority from Japanese Patent Application No. 2009-062198, filed Mar. 16, 2009, the entire contents of which are incorporated herein by reference.

### BACKGROUND

1. Field

One embodiment of the present invention relates to a magnetic recording/reproduction apparatus used as a hard disk drive, a magnetic head used in it, and a method of manufacturing the magnetic recording/reproduction apparatus.

2. Description of the Related Art

A magnetic recording apparatus comprises, for example, a hard disk having a magnetic layer for recording data and a magnetic head having a element. The recording/reproduction element is attached to the distal end of the slider of the magnetic head and placed above the hard disk at the time of recording or reproduction. The slider runs while flying due to airflow generated by rotation of the hard disk. In this state, the recording/reproduction element records or plays back data on or from the magnetic layer.

In recent years, to improve the recording density of the magnetic layer of a hard disk, the flying height of the slider with respect to the hard disk is reduced to 10 nm or less. The distance between the magnetic layer of the hard disk and the recording/reproduction element of the slider is called a magnetic spacing.

When the flying height decreases, the slider and the hard disk may come into contact and damage each other. To prevent the damage, a lubricating layer is applied to a thickness of about 1 nm on the surface of the hard disk to increase the reliability of the magnetic recording apparatus.

However, as the magnetic spacing becomes narrower, the lubricant on the hard disk surface readily adheres to the slider due to intermittent contact between it and the hard disk, evaporation, or the like. When the lubricant is accumulated on the slider, it is easily adsorbed by the hard disk via the lubricant and finally causes a head crash.

It is therefore necessary to prevent the lubricant from adhering to the slider surface. A lubricant adhesion preventing method is known, which forms a solid resin film on a slider surface called an air bearing surface opposing the hard disk to reduce the surface free energy of the air bearing surface, thereby suppressing lubricant adhesion.

However, adapting the structure with the resin film formed on the air bearing surface causes a flying height increase corresponding to the thickness of the resin film, contrary to the tendency of smaller slider flying height aiming at improving the recording density. In addition, as the slider flying accumulation time is prolonged, the lubricant accumulation preventing effect may be weaker.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a plan view showing the stracture of a magnetic recording apparatus according to an embodiment of the present invention;

FIG. 2A is a side view showing a magnetic head according to the embodiment of the present invention;

FIG. 2B is a plan view corresponding to FIG. 2A;

FIG. 3 is a graph showing the film thickness distribution of a resin film formed on the magnetic head according to the embodiment of the present invention;

FIG. 4 is a graph showing the adhered film thickness distribution of a lubricant or the like after flying and running of the magnetic head according to the embodiment of the present invention;

FIG. 5 is a graph showing the film thickness distribution of a resin film formed on the slider of a magnetic head according to Comparative Example 2;

FIG. 6 is a graph showing the adhered film thickness distributions of a lubricant or the like after flying and running of the magnetic heads according to Comparative Examples 1 and 2;

FIGS. 7A, 7B, and 7C are side views showing steps in forming the resin film on the slider of the magnetic head according to the present invention;

FIG. 8 is a graph showing surface free energy on an ABS and the distal end face of the slider of the magnetic head according to the embodiment of the present invention; and

FIG. 9 is a graph showing the adhered film thickness on the ABS and the distal end face of the magnetic head according to the embodiment of the present invention.

### DETAILED DESCRIPTION

Various embodiments according to the invention will be described hereinafter with reference to the accompanying drawings. In general, according to one embodiment of the invention, there is provided a magnetic head comprising a slider, a recording/reproduction element formed on a distal end face of the slider, and a resin film formed at least on the recording/reproduction element and the distal end face and having water repellency and/or oil repellency.

According to another aspect of the present invention, there is provided a magnetic recording/reproduction apparatus comprising a magnetic head comprising a slider, a recording/reproduction element formed on a distal end face of the slider, and a resin film formed on the recording/reproduction element and the distal end face and having water repellency and/or oil repellency, and a magnetic disk having a lubricating layer on a surface that opposes the magnetic head upon recording/reproduction.

According to still another aspect of the present invention, there is provided a method of manufacturing a magnetic recording/reproduction apparatus, comprising the steps of forming a resin film at least on a distal end face of a slider of a magnetic head arranged to oppose a magnetic disk, and irradiating the resin film on the distal end face with high-energy radiation to fix the resin film to the distal end face.

According to the present invention, a resin film is formed on the distal end face of the slider of a magnetic head where a recording/reproduction element is formed. Preventing a lubricant or the like for adhering to the distal end face enables suppression of a crash of the magnetic head on the magnetic recording medium upon recording/reproduction.

An embodiment of the present invention will now be described with reference to the accompanying drawing. The same reference numerals denote the same constituent elements throughout the drawing.

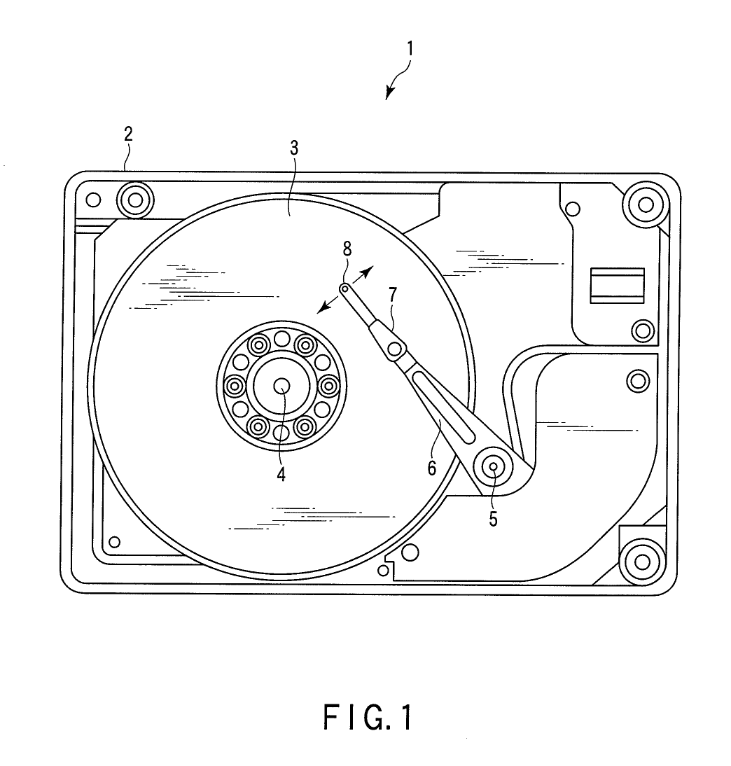

FIG. 1 is a plan view showing the interior of a magnetic recording apparatus according to an embodiment of the present invention.

A magnetic disk 3 serving as a magnetic recording medium is arranged in a housing 2 of a magnetic recording apparatus 1 so as to be rotatable by a spindle motor 4. A leaf-spring-shaped suspension 7 is connected to the distal end of a suspension arm 6.

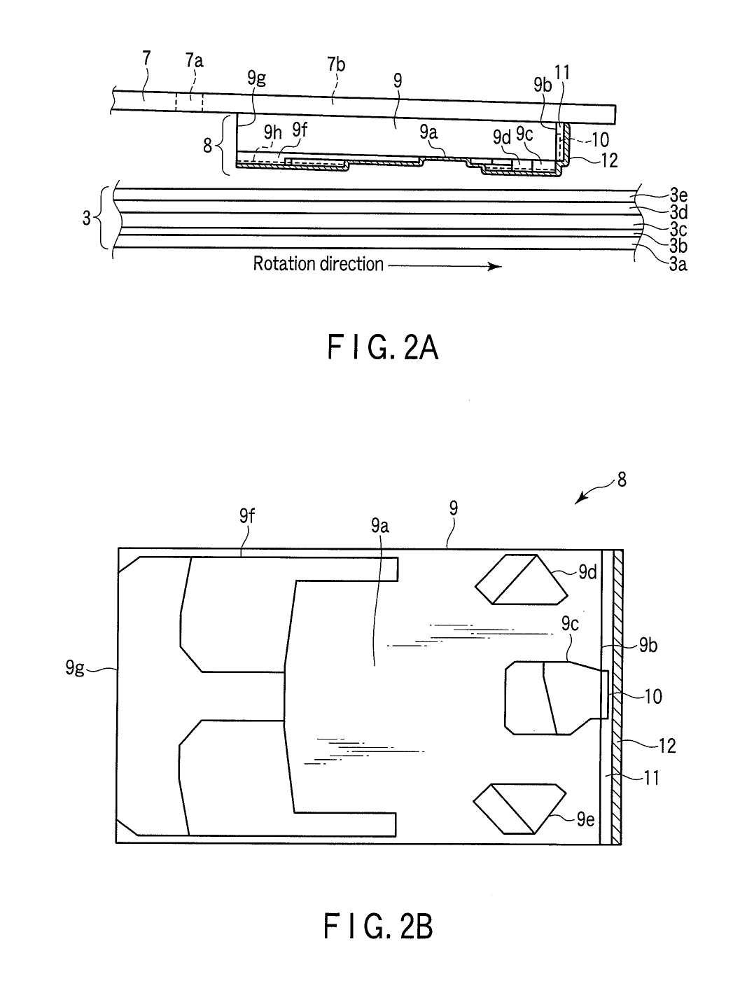

As shown in FIG. 2A, a gimbal 7b having a cantilever structure and surrounded by a C-shaped hole 7a is formed at the distal end portion of the suspension 7. A magnetic head 8 is attached to the lower surface of the gimbal 7b.

FIG. 2A is a side view showing the magnetic head according to the embodiment of the present invention.

FIG. 2B is a plan view corresponding to FIG. 2A.

The magnetic head 8 shown in FIG. 2A is flying on the rotating magnetic disk 3 while tilting with its distal end closer to the magnetic disk 3 than the rear end.

The magnetic disk 3 is constructed by sequentially forming a chromium underlayer 3b, magnetic layer 3c, and protective layer 3d on a nonmagnetic substrate 3a such as a glass substrate and further forming a lubricating layer 3e on the protective layer 3d. The lubricating layer 3e is made using, for example, perfluoropolyether having hydroxyl groups at the two molecular terminals, and has a thickness of, e.g., about 1 to 2 nm.

To retreat the magnetic head 8 from the recording surface when the magnetic disk 3 is stationary, the CSS scheme of stopping the magnetic head on a non-recording surface of the magnetic disk 3, or the load/unload scheme of moving the magnetic head to a ramp loading mechanism portion (not shown) outside the magnetic disk 3 is usable. The magnetic recording apparatus 1 can employ a gas/liquid mixing lubrication scheme which makes a part of the magnetic head 8 contact with the magnetic disk 3 and another part float, or a contact scheme of always keeping the magnetic head 8 in contact with the magnetic disk 3.

The magnetic head 8 has a slider 9 having a rectangular planar shape, as shown in FIG. 2B. The slider 9 has an air bearing surface (ABS) 9a on the lower side. Out of the ABS 9a, a region close to a distal end face 9b includes first to third projections 9c, 9d, and 9e having heights of several microns. A region close to a rear end face 9g has a fourth projection 9f having heights of several microns.

The first to third projections 9c, 9d, and 9e are thicker in the front part than in the rear part. The fourth projection 9f is formed thicker in the T-shaped region at the rear and central parts than in other portions. Surface layer portions 9h of the first to fourth projections 9c to 9f are made of diamond like carbon (DLC).

A recording/reproduction element 10 is formed on the distal end face 9b of the slider 9. The recording/reproduction element 10 comprises a recording element having an induction coil and yoke for recoding, and a magnetoresistive element for reproduction. As the magnetoresistive element, for example, an MR element, TMR element, GMR element, or the like is used. Note that the distal end face 9b is almost perpendicular to the ABS 9a.

For example, an alumina film serving as a protective film 11 is formed on the distal end face 9b of the slider 9 to cover the recording/reproduction element 10. A resin film 12 is formed on the protective film 11 that covers the distal end face 9b. The resin film 12 is formed on the ABS 9a and projections 9c to 9f of the slider 9 as well. The resin film 12 has a thickness of 0.7 nm or less. Note that in this embodiment, the film thickness value indicates the average value in a predetermined region.

As the material of the resin film 12, a resin having at least one of water repellency and oil repellency, for example, a fluorocarbon resin is applied. Examples of fluorocarbon resins are a perfluoropolyether, perfluoroalkane having the number of carbons of 1 to 10, perfluoroalkene having the number of carbons of 1 to 10, and ethers with an oxygen atom intervening between carbon atoms of such a perfluoroalkane or perfluoroalkene.

For example, the perfluoropolyether is represented by

R—[(O—CF₂—CF₂)ₘ—(O—CF₂)ₙ]—O—R (1)

wherein the ether linkage R indicates an end group which is, for example, trifluoromethyl (—CH₃), and m and n are real numbers of 0 or more which are not 0 simultaneously. In the formula (1), structural unit (O—CF₂—CF₂) and structural unit (O—CF₂) may have a sequence random or blocked to each other.

The end group R of the perfluoropolyether may be a polar functional group including a hydroxyl group, as indicated by, e.g.,

—CH₂OH (2)

—CH₂—O—CH₂—CH(OH)—CH₂—OH (3)

The hydroxyl group is a molecule which increases adsorption to the surface of the slider 9. The perfluoropolyether may be a polymer having phosphazene rings. The perfluoroalkane is represented by

CF₃—(CF₂)ₙ—CF₃ (4)

The perfluoroalkene is represented by

CF₃—CF═CF—(CF₂)ₙ—CF₃ (5)

Alternatively, an organic fluorine compound selected from a group consisting of mixtures of one of a perfluoroalkane, perfluoroalkene, and ether may be applied as the material of the resin film 12. The organic fluorine compound may contain hydrogen.

As described above, according to the embodiment, the resin film 12 is formed on the ABS 9a and distal end face 9b of the slider 9. The resin film 12 suppresses adhesion of a lubricant or the like to the slider 9 even in case of short-time contact with the lubricating layer 3e of the magnetic disk 3 or evaporation of the lubricant from the lubricating layer 3e.

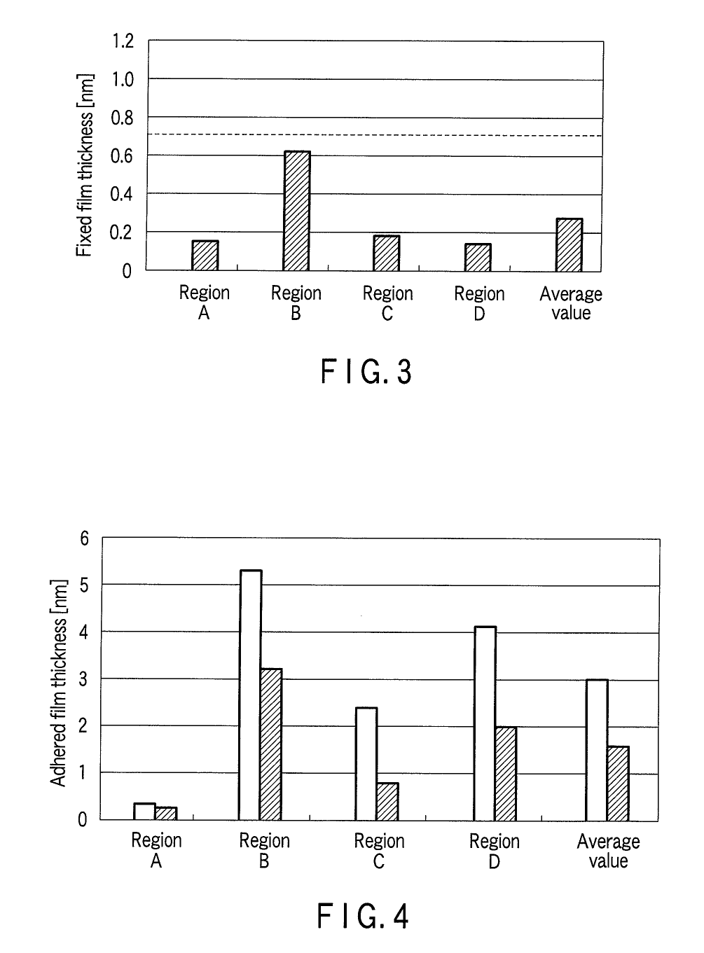

The magnetic head 8 is prepared, for which the resin film 12 having a film thickness distribution of 0.7 nm or less, as shown in FIG. 3, is formed on the distal end face 9b and projections 9c to 9f of the slider 9. In this case, the perfluoropolyether can be applied as the material of the resin film 12, and a dipping method can be used as the coating method. In addition, a magnetic head for which no resin film is formed on the slider 9 is prepared as Comparative Example 1.

FIG. 3 is a graph showing the film thickness distribution of the resin film formed on the slider of the magnetic head according to the embodiment of the present invention.

Referring to FIG. 3, region A indicates the top face of the fourth projection 9f close to the rear end face 9g of the slider 9 shown in FIG. 2B. Region B indicates the ABS 9a around the first to third projections 9c, 9d, and 9e close to the distal end face 9b of the slider 9. Region C indicates the top faces of the first to third projections 9c, 9d, and 9e. Region D indicates the distal end face 9b of the slider 9 and, more particularly, a region on (in the horizontal direction of the drawings) the recording/reproduction element 10. Note that regions A to D indicate the same positions as described above in the following explanation.

After each two types of magnetic heads 8 which were mounted on deferent sliders floated and ran on the magnetic disk 3 for 66 hours at average floating height of 10 mm, the adhered film thicknesses of the lubricant or the like on the magnetic heads 8 were checked. A lubricant layer having a thickness of 1.0 μm was formed on the magnetic disk 3. The results shown in FIG. 4 were obtained.

FIG. 4 is a graph showing the adhered film thickness distribution of the lubricant or the like after floating and running of the magnetic head according to the embodiment of the present invention.

Of the two bars of each of regions A, B, C, and D, the right-side bar indicates the adhered film thickness of the embodiment of the present invention, and the right-side bar indicates the adhered film thickness of Comparative Example 1.

According to FIG. 4, the adhered film thickness of the lubricant or the like decreased to about 30 to 60% in regions B, C, and D of the magnetic head 8 of this embodiment as compared to regions B, C, and D of the magnetic head of Comparative Example 1. Region A of the magnetic head 8 of the embodiment is compared with that of the magnetic head of Comparative Example 1. The adhered film thickness of the lubricant or the like is almost the same. The thickness is as small as 5 nm or less and rarely influences a crash.

As can be seen, forming the resin film 12 in regions A to D of the slider 9 can effectively prevent adhesion of the lubricant.

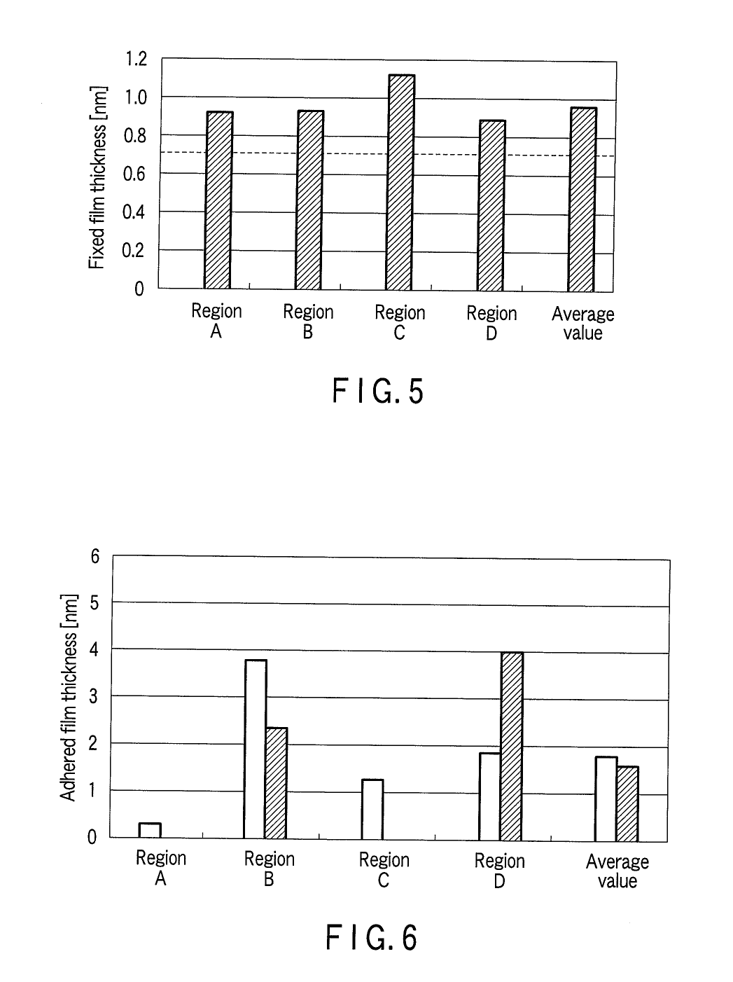

As Comparative Example 2, a magnetic head 8 with a resin film having a thickness of 0.8 nm or more, as shown in FIG. 5, on the ABS 9a, distal end face 9b, and projections 9c to 9f of the slider 9 is prepared. In addition, the magnetic head of Comparative Example 1 without any resin film formed on the slider 9 is prepared.

FIG. 5 is a graph showing the film thickness distribution of the resin film formed on the slider of the magnetic head according to Comparative Example 2.

After the two types of magnetic heads floated and ran on the magnetic disk 3 for 24 hours, the adhered film thicknesses of the lubricant or the like on the magnetic heads were checked. The results shown in FIG. 6 were obtained.

FIG. 6 is a graph showing the adhered film thickness distributions of the lubricant or the like after floating and running of the magnetic heads according to Comparative Examples 1 and 2.

Of the two bars of each of regions A, B, C, and D, the left-side bar indicates the adhered film thickness of Comparative Example 1, and the right-side bar indicates the adhered film thickness of Comparative Example 2.

According to FIG. 6, the adhered film thickness of the lubricant or the like was smaller in regions A, B, and C of the magnetic head of Comparative Example 2 than in regions A, B, and C of the magnetic head of Comparative Example 1 without the resin film.

On the other hand, the adhered film thickness of the lubricant or the like was larger in region D of the magnetic head, i.e., on the distal end face 9b of the slider 9 of Comparative Example 2, than in region D of the magnetic head of Comparative Example 1. The degree of adhesion at the distal end portion 9b is also influenced by the thickness of the resin film on the ABS 9a and the first to third projections 9c, 9d, and 9e.

As is apparent, forming the resin film 12 having a thickness of 0.8 nm or more on the slider 9 readily causes a crash of the magnetic head.

As described above, the thickness of the resin film 12 formed on the ABS 9a, distal end face 9b, and projections 9c, 9d, and 9e of the slider 9 to prevent a crash of the magnetic head 8 on the magnetic disk 3 can be 0.7 nm or less.

If the resin film 12 is thinner than 0.5 nm, the surface free energy to be described later increases. Hence, the lubricant or the like readily adheres in long-time use. Especially, the thickness of the resin film 12 can be 0.5 nm or more.

Referring to FIGS. 4 and 6, the adhered film thickness of the lubricant or the like is large in regions B and D.

In region B, however, even when the lubricant or the like adheres thick, it does not cause a magnetic head crash. Region B exists around the first to third projections 9c to 9e of the slider 9, and sinks by several microns with respect to the first to third projections 9c to 9e. For this reason, even when the lubricant or the like adheres there in a thickness of several nanometers, the lubricant or the like never comes into contact with the magnetic disk 3.

In contrast, region D, i.e., the distal end face 9b of the slider 9, and, more particularly, the region on the recording/reproduction element 10 is closest to the magnetic disk 3. The degree of adhesion of the lubricant or the like needs to be decreased. If the lubricant or the like readily adheres to the distal end face 9b of the slider 9, the adhered substance grows and spreads toward the ABS 9a to easily cause a crash.

Since the lubricant or the like adheres to even the ABS 9a and projections 9c to 9e, their surfaces can also be covered with the resin film 12. However, if the resin film 12 is formed thick on the ABS 9a and projections 9c to 9e, problems occur when narrowing the magnetic spacing between the slider 9 and the magnetic disk 3. Additionally, the degree of adhesion to the distal end face 9b increases.

The resin film 12 on the ABS 9a and projections 9c to 9e of the slider 9 can be formed thinner than on the distal end face 9b. The film thickness is adjusted by the following method.

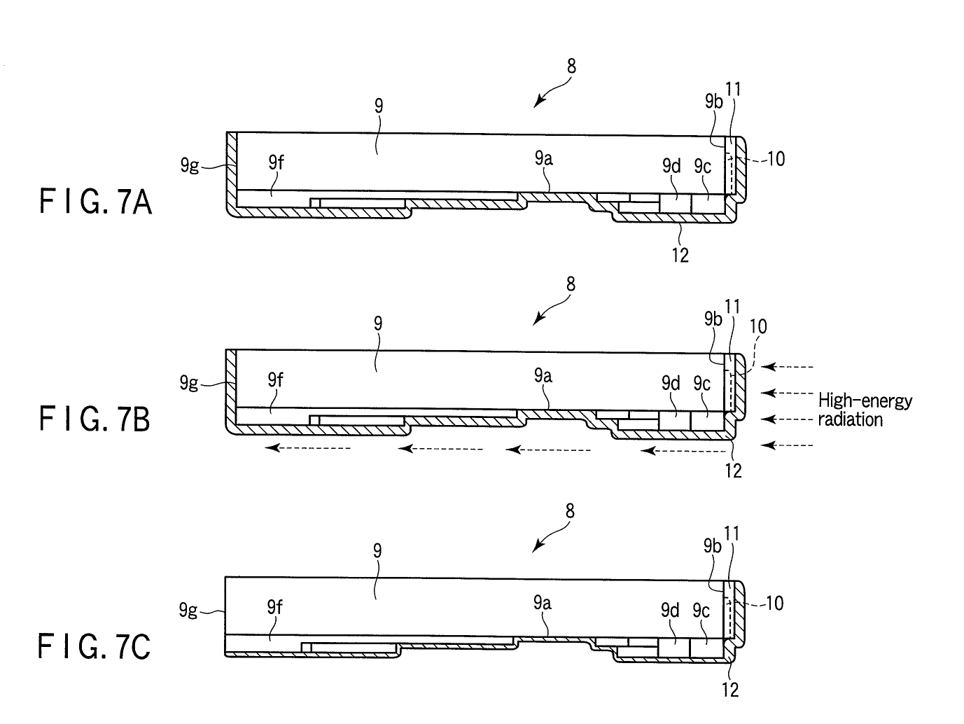

FIGS. 7A to 7C are side views showing steps in forming the resin film on the slider of the magnetic head according to the present invention.

First, as shown in FIG. 7A, the resin film 12 is applied to the ABS 9a, distal end face 9b, projections 9c to 9f, rear end face 9g, and side surfaces of the slider 9 of the magnetic head 8. Note that the resin film 12 on the distal end face 9b is applied to the protective film 11 on the recording/reproduction element 10.

To apply the resin film 12, a dipping method of dipping the slider 9 in a resin liquid and then raising it and an injection method of directly injecting a resin liquid to the distal end face 9b and the like of the slider 9 via the pores of, e.g., a capillary tube are usable. Still another application method exposes the slider 9 to resin vapor. As a resin to generate a resin vapor, for example, C₄F₉OCH₃ is usable.

As a method of controlling the thickness of the resin film 12, for example, the resin film 12 is stacked while changing its type. When the dipping method is used, the film thickness can be controlled either by changing at least one of the resin solution concentration, dipping time, and raise speed of the slider 9 from the dipping solution or by a method of controlling the dose of high-energy radiation to be described next. When a liquid resin is used, the resin film 12 may be heated to 100 to 200 C to change the orientation of resin molecules before the next high-energy irradiation process so that the film thickness or density of the resin layer changes after high-energy irradiation.

Note that when applying the resin to the slider 9 using the above-described methods, the slider 9 may be attached to the suspension 7.

Next, as shown in FIG. 7B, the resin film 12 is irradiated with high-energy radiation such as ultraviolet light or an electron beam from a direction perpendicular to the distal end face 9b of the slider 9, thereby fixing the resin film 12 to the protective film 11. Note that in FIG. 7B, the irradiation direction is slightly changed from the direction perpendicular to the distal end face 9b toward the ABS 9a so that the high-energy radiation faintly irradiates the ABS 9a and projections 9c to 9f of the slider 9.

Finally, as shown in FIG. 7C, the resin which is not bonded to the slider 9 and the protective film 11 on the ABS 9a, distal end face 9b, and projections 9c to 9f of the slider 9 is rinsed using a solvent so that only firmly cured resin molecules can remain as the resin film 12.

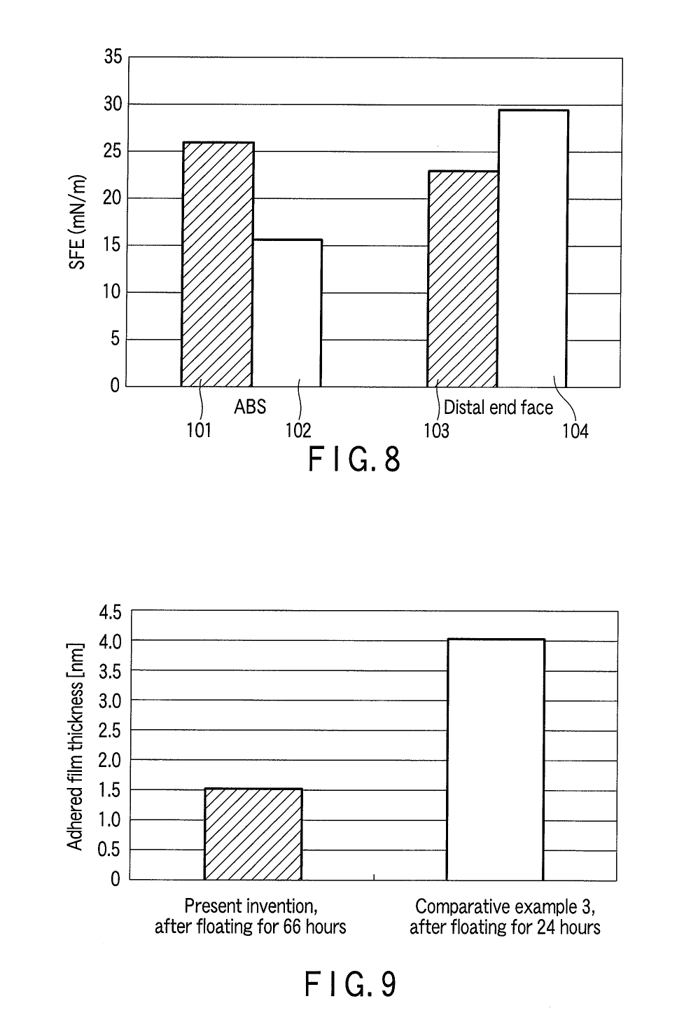

FIG. 8 is a graph showing the surface free energy on the ABS and the distal end face of the slider of each of the magnetic heads according to the embodiment of the present invention and Comparative Example 3.

Of the two bars of each of the ABS and the distal end face, the left-side bar indicates the surface free energy on the magnetic head of the embodiment of the present invention, and the right-side bar indicates the surface free energy of Comparative Example 3.

The surface free energy (SFE) of the resin film 12 formed by the above-described method is about 26 mN/m on the ABS 9a and projections 9c to 9f of the slider 9, as indicated by, e.g., the hatched bar 101 in FIG. 8. On the other hand, the SFE of the resin film 12 on the distal end face 9b of the slider 9 is about 23 mN/m as indicated by the hatched bars 103. Note that the smaller the SFE is, the thicker the resin film 12 is.

As Comparative Example 3, a magnetic head is formed by irradiating the resin film 12 on the ABS 9a with high-energy radiation from a direction perpendicular to the ABS 9a of the slider 9.

FIG. 8 is a graph showing the surface free energy on the ABS and the distal end face of the slider.

The SFE of the resin film 12 on the ABS 9a and projections 9c to 9f is about 15 mN/m, as indicated by, e.g., the hollow bar 102 in FIG. 8. The SFE of the resin film 12 on the distal end face 9b is about 30 mN/m as indicated by the hollow bar 104.

Table 1 compares the thickness and SFE of the resin film covering the slider 9 of the embodiment with those of Comparative Example 3. Note that the floating surface in Table 1 includes projections 9c to 9f.

TABLE 1

| | | | Comparative |
|---|---|---|---|
| | | Embodiment | example 3 |
| Film thickness of | | Thin | Thick |
| resin layer | | (0.7 nm or less) | (0.8 nm or more) |
| SFE of | Floating | Greater than | Less than on |
| resin | surface | or equal to that | distal end face |
| film | | on distal end face | |
| | Distal end | Less than or | Greater than on |
| | face | equal to that on | floating surface |
| | | floating surface | |

After the magnetic head 8 of the embodiment shown in Table 1 floated and ran on the magnetic disk 3 for 66 hours, the adhered film thicknesses of the lubricant or the like on the slider 9 was measured. The adhered film thickness was about 1.5 nm as indicated by the hatched bar in FIG. 9.

After the magnetic head of Comparative Example 3 shown in Table 1 floated and ran on the magnetic disk for 24 hours, the adhered film thicknesses of the lubricant or the like on the slider was measured.

FIG. 9 is a graph showing the adhered film thickness on the ABS and the distal end face of the magnetic head according to the embodiment of the present invention.

As a result, the adhered film thickness increased to about 4.0 nm as indicated by the hollow bar in FIG. 9, although the running time shortened to ⅓ that of the magnetic head 8 of the embodiment.

That is, when the resin film 12 on the slider 9 is formed thicker on the distal end face 9b than on the ABS 9a and projections 9c to 9f, the degree of adhesion of the lubricant or the like to the magnetic head 8 can be reduced, and the magnetic spacing can also be narrowed. If the resin film 12 is too thin, the SFE increases, and the lubricant or the like readily adheres. Hence, the SFE of the resin film 12 may be 25 mN/m or less. In consideration of the SFE, the thickness of the resin film 12 on the distal end face 9b may be 0.5 nm or more.

Note that to obtain the SFE, the contact angle of two or more kinds of liquids is measured, and the value of adhesion work is obtained. After that, the SFE can be obtained based on these values. The contact angle of liquids is obtained by, e.g., the Zisman method.

When the adhered film thickness of the lubricant or the like shown in FIG. 6 is taken into consideration, the resin film 12 is formed on the distal end face 9b that is region D, whereas no resin film 12 need be formed in regions A to C, i.e., on the ABS 9a and projections 9c to 9f.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head comprising:
a slider;
a recording/reproduction unit positioned at a distal end face of the slider; and
a resin film on at least the recording/reproduction unit and the distal end face and having at least water repellency or oil repellency.

2. The head of claim 1, wherein the resin film extends to an air bearing surface of the slider, the resin film on the air bearing surface is thinner than the resin film on the distal end face.

3. The head of claim 1, wherein the resin film on the distal end face has a minimum thickness of 0.5 nm.

4. The head of claim 2, wherein the resin film on the air bearing surface has a maximum thickness of 0.7 nm.

5. The head of claim 2, wherein a surface free energy of the resin film on the distal end face is smaller than a surface free energy of the resin film on the air bearing surface.

6. A magnetic recording/reproduction apparatus comprising:
a magnetic head comprising a slider, a recording/reproduction unit on a distal end face of the slider, and a resin film on the recording/reproduction unit and the distal end face and having at least water repellency or oil repellency; and
a magnetic disk having a lubricating layer on a surface that opposes the magnetic head upon recording or reproduction.

7. The apparatus of claim 6, wherein the resin film is on an air bearing surface of the slider, and the resin film on the air bearing surface is thinner than the resin film on the distal end face.

8. The apparatus of claim 6, wherein the resin film on the distal end face has a minimum thickness of 0.5 nm.

9. The apparatus of claim 7, wherein the resin film on the air bearing surface has a maximum thickness of 0.7 nm.

10. The apparatus of claim 7, wherein a surface free energy of the resin film on the distal end face is smaller than a surface free energy of the resin film on the air bearing surface.

11. A method of manufacturing a magnetic recording apparatus, comprising the steps of:
forming a resin film on a distal end face of a slider of a magnetic head arranged to face a magnetic disk; and
irradiating the resin film on the distal end face with high-energy radiation to fix the resin film to the distal end face.

12. The method of claim 11, wherein the resin film is further formed on an air bearing surface of the slider, and the resin film formed on the air bearing surface is thinner than the resin film on the distal end face.

13. The method of claim 11, wherein the resin film on the distal end face has a minimum thickness of 0.5 nm.

14. The method of claim 12, wherein the resin film on the air bearing surface has a maximum thickness of 0.7 nm.

15. The method of claim 12, wherein a surface free energy of the resin film on the distal end face is smaller than a surface free energy of the resin film on the air bearing surface.
